(19) United States
(12) Patent Application Publication
(10) Pub. No.: US 2005/0046786 A1
(43) Pub. Date: Mar. 3, 2005

(54) Rotatable and removable auxiliary eyewear system

(76) Inventor: Greg Smith, Plano, TX (US)

Correspondence Address: STORM & HEMINGWAY, L.L.P., 8117 PRESTON RD., STE. 460, DALLAS, TX, 75225, US

(21) Appl. No.: 10/767,544

(22) Filed: Jan. 29, 2004

Related U.S. Application Data
(60) Provisional application No. 60/498,936, filed on Aug. 29, 2003.

(51) Int. Cl. G02C 9/00

(52) U.S. Cl. 351/47

(57) ABSTRACT

The present invention discloses a unique and novel system for attaching an auxiliary lens assembly to a primary lens assembly in which the attachment includes two alternative positions, a lowered position and a raised position. In the lower position, the person wearing the eyewear system views through both the primary lenses and auxiliary lenses. Primary magnets attach to auxiliary extensions to magnetically secure the assemblies in the lowered position. The auxiliary lens assembly may easily be flipped upwards into the raised position. The opposite side of the primary magnets attach to auxiliary magnets to magnetically secure the assemblies in the raised position. In the raised position, the person wearing the eyewear system views only through the primary lenses. As a further option, the auxiliary lens assembly is easily removable from the primary lens assembly, allowing for separate storage of the auxiliary lens assembly when not needed.

### RELATED ART

This application claims priority to U.S. Provisional Patent No. 60/498,936, which was filed on Aug. 29, 2003.

### TECHNICAL FIELD OF INVENTION

The present invention relates to eyewear, and in particular, to a design for and auxiliary lens assembly and primary lens assembly combination in which the auxiliary lens assembly is adapted for rotatable and removable attachment to the primary lens assembly. More specifically, the present invention discloses to an auxiliary eyewear support system utilizing a novel design that utilizes magnets to permit rotation of the auxiliary frame from a magnetically engaged position to a magnetically engaged second position in which the auxiliary frame assembly is flipped up substantially perpendicular to the orientation of the primary frame assembly.

### BACKGROUND OF THE INVENTION

It has long been desirable to have a removable auxiliary lenses attached to eyeglasses. Professional baseball players have used “flip-up” auxiliary lenses for more than three decades to protect their eyes from the sun, but to allow them unrestricted vision in the event the ball was hit in their vicinity.

These and other mechanically clipped on devices for holding auxiliary lenses are cumbersome and unattractive. More recently, numerous attempts have been made to magnetically attach an auxiliary lens assembly to a primary lens assembly.

U.S. Pat. No. 4,070,103 to Meeker discloses a primary lens assembly having a slidably attachable auxiliary lens assembly. In this device, the primary lens assembly is made of magnetizable material and auxiliary lenses are individually securable to the primary lens assembly by a magnetic band inserted in a groove on the inside surface of the individual auxiliary lens assembly.

U.S. Pat. No. 5,416,537 to Sadler discloses a primary lens assembly having a first magnetic member attached vertically to the front surface of the primary lens assembly, and a second magnetic member attached in a corresponding position on the back surface on an auxiliary lens assembly. The magnetic members are arranged for engagement to secure the auxiliary lens assembly to the primary lens assembly. This design suffers from exclusive reliance on magnetic engagement and frequent disengagement of the auxiliary lens in the presence of the normal forces of impact and acceleration that are realized in daily activity or exercise.

U.S. Pat. No. 5,568,207 to Chao also discloses a magnetically adhered auxiliary lens assembly, with the additional feature of arms extending from the side portions of the auxiliary lens assembly, over magnet retaining projections and extensions of the primary lens assembly. The arms engage with, and are supported on, the primary lens assembly extensions to prevent disengagement of the auxiliary lens assembly upon downward movement of the auxiliary lens assembly relative to the primary lens assembly.

U.S. Pat. No. 5,737,054 to Chao also discloses a magnetically and mechanically attached auxiliary lens assembly in which the design is essentially identical to that of U.S. Pat. No. 5,568,207, except that the location of the hooking engagement and magnets is in the bridge portion of the auxiliary and primary lens assemblies.

Auxiliary eyewear systems such as those described above require the auxiliary frame assembly be removed from the primary frame assembly, and then handled and stored separately when it is necessary for the eyeglass wearer to look only through the lenses of the primary frame assembly.

It can thus be seen that there is a need to develop a design for an auxiliary frame assembly and primary frame assembly combination in which the auxiliary frame assembly can be flipped into a position in which the contribution of the auxiliary lenses is temporarily removed, without detaching the auxiliary lens assembly from the primary frame assembly.

### SUMMARY OF THE INVENTION

A primary advantage of the present invention is that it provides an auxiliary lens assembly and primary lens assembly combination in which the auxiliary lens assembly is designed to securely attach to the primary lens assembly. Another advantage of the present invention is that it provides a means of temporary displacement of the auxiliary lenses without a need for complete removal of the auxiliary lens assembly.

Another advantage of the present invention is that temporary displacement of the auxiliary lenses can be accomplished without a need to separately hold or store the auxiliary lens assembly. Another advantage of the present invention is that temporary displacement is accomplished without the use of gears or sliding members. Another advantage of the present invention is that it provides the option of complete removal of the auxiliary lens assembly.

Other advantages of the present invention will become apparent from the following descriptions, taken in connection with the accompanying drawings, wherein, by way of illustration and example, an embodiment of the present invention is disclosed. As referred to hereinabove, the “present invention” refers to one or more embodiments of the present invention which may or may not be claimed, and such references are not intended to limit the language of the claims, or to be used to construe the claims in a limiting manner.

In accordance with one aspect of the invention, there is provided a primary lens assembly retaining a pair of primary lenses. An auxiliary lens assembly retains a pair of auxiliary lenses. The auxiliary lens assembly may be attached to the primary lens assembly. In this manner, the person wearing the eyewear system has two lenses combining to alter the transmission of light to each eye.

In a preferred embodiment, the primary lens is a corrective lens and the auxiliary lens is a light transmission reducing lens, for example, a polarizing, absorbing, refracting, photochromatic, or reflecting lens, or any combination thereof (i.e., sunglasses) In another preferred embodiment, the primary lens is a corrective lens and the auxiliary lens is a corrective lens. In another preferred embodiment, the primary lens is a corrective lens and the auxiliary lens is an impact resistant safety lens.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of a preferred embodiment of the present invention, disclosing a primary lens assembly and an auxiliary lens assembly illustrating the assemblies attached, with the auxiliary lens assembly in the lower position.

FIG. 2 is an isometric view of the preferred embodiment disclosed in FIG. 1, illustrating the primary lens assembly by itself.

FIG. 3 is an isometric breakout view of the preferred embodiment of the primary lens assembly of FIG. 2.

FIG. 4 is an isometric view of the preferred embodiment disclosed in FIG. 1, illustrating the auxiliary lens assembly by itself.

FIG. 5 is an isometric breakout view of the preferred embodiment of the auxiliary lens assembly of FIG. 2.

FIG. 6 is a top view of the preferred embodiment disclosed in FIG. 1, illustrating the primary lens assembly and the auxiliary lens assembly attached with the auxiliary lens assembly in the lowered position.

FIG. 7 is a side view of the preferred embodiment disclosed in FIG. 1, illustrating the primary lens assembly and the auxiliary lens assembly attached with the auxiliary lens assembly in the lowered position.

FIG. 8 is an isometric breakout view of the preferred embodiment disclosed in FIG. 7, illustrating the assemblies attached, with the auxiliary lens assembly in the lowered position, and illustrating the magnetic engagement between the primary magnet and the auxiliary extension.

FIG. 9 is a side view of the preferred embodiment, illustrating the assemblies attached, with the auxiliary lens assembly in the lowered position, and illustrating the magnetic engagement between the primary magnet and the auxiliary extension.

FIG. 10 is a side view of the preferred embodiment illustrated in FIG. 8, illustrating the assemblies attached, with the auxiliary lens assembly in the raised position, and illustrating the magnetic engagement between the primary magnet and the auxiliary magnet.

FIG. 11 is a front view of the preferred embodiment disclosed in FIG. 1, illustrating the assemblies attached, with the auxiliary lens assembly in the raised position.

FIG. 12 is an isometric breakout view of another preferred embodiment

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The terms “right” and “left” as used herein are referenced from the perspective of a person wearing the primary and auxiliary lens assemblies. The references are intended to aide in the description of the device, and are not intended to be limiting, since the preferred embodiments of the device are generally symmetric.

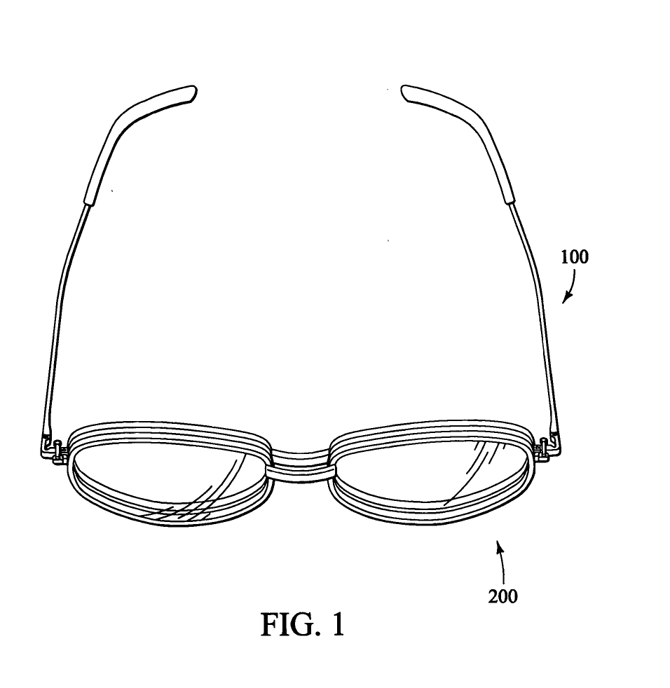

FIG. 1 is an isometric view of a preferred embodiment of the present invention. In this view, a primary lens assembly 100 is illustrated with an auxiliary lens assembly 200 attached.

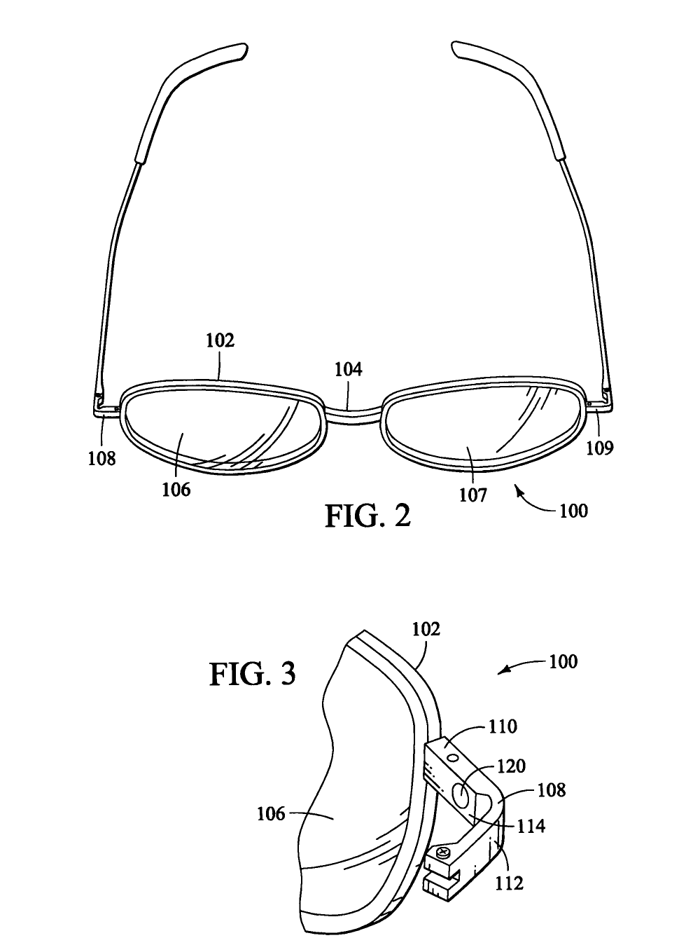

FIG. 2 is a front view of a preferred embodiment of primary lens assembly 100. In the embodiment shown in this view, primary lens assembly 100 includes a primary frame 102. Primary frame 102 has a primary bridge 104. Primary frame 102 retains a right lens 106 and a left lens 107. Primary frame 102 has a primary extension 108 extending outward from the right side of primary frame 102. Primary frame 102 has a primary extension 109 extending outward from the left side of primary frame 102. In a preferred embodiment, a leg 130 is pivotally attached to primary extension 108 and a leg 131 is pivotally attached to primary extension 109.

FIG. 3 is isometric breakout view of the embodiment of primary lens assembly 200 shown in FIG. 2. While this view illustrates the right side of primary lens assembly 200, the left side is symmetrically configured. As shown in this view, primary extension 108 has a top surface 110, a front surface 112, and a rear surface 114. A primary magnet 120 is located within primary extension 108. In the preferred embodiment, primary magnet 120 is located approximately flush to rear surface 114.

On the left side of primary frame 102 (not shown) primary extension 109 also has a top surface 111, a front surface 113, a rear surface 115, and a primary magnet 121 located within primary extension 109. Primary magnets 120 and 121 may have a cylindrical geometry. If so, the flat surfaces (cylinder ends) of primary magnets 120 and 121 are preferably oriented in approximate parallel relationship to the surfaces of right and left lenses 106 and 107.

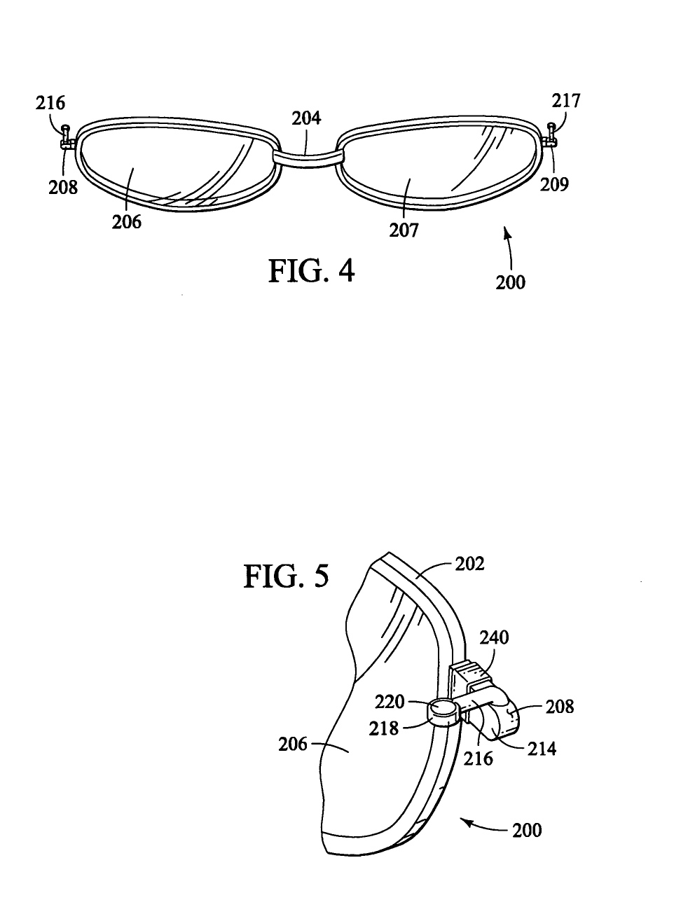

FIG. 4 is a front view of a preferred embodiment of auxiliary lens assembly 200. In the embodiment shown in this view, auxiliary lens assembly 200 includes an auxiliary frame 202. Auxiliary frame 202 has an auxiliary bridge 204. Auxiliary frame 202 retains a right lens 206 and a left lens 207. Auxiliary frame 202 has an auxiliary extension 208 extending outward from the right side of auxiliary frame 202. Auxiliary frame 202 has an auxiliary extension 209 extending outward from the left side of auxiliary frame 202.

In the preferred embodiment, auxiliary extensions 208 and 209 are made of a magnetic material. “Magnetic material” as used herein is defined as materials subject to attraction by magnetic force, or magnetically attractable. In an alternative embodiment, a magnetic member is included in auxiliary extensions 208 and 209. “Magnetic members” are defined to comprise the group of both magnets and magnetic materials. In another alternative embodiment, auxiliary extensions 208 and 209 are magnets. Thus, in the various disclosed embodiments, auxiliary extensions 208 and 209 are magnetically attractable.

FIG. 5 is isometric breakout view of the embodiment of auxiliary lens assembly 200 shown in FIG. 4. While this view illustrates the right side of auxiliary lens assembly 200, the left side is symmetrically configured. As shown in this view, auxiliary extension 208 has a rear side 214. An arm 216 extends rearward from auxiliary extension 208. In this embodiment, a retainer 218 is located at the end of arm 216. An auxiliary magnet 220 is located within retainer 218 of arm 216.

On the left side of auxiliary frame 202, (not shown) auxiliary extension 209 also has a rear side 215, an arm 217 extending rearward, a retainer 219, and an auxiliary magnet 221 located within a retainer 219. Auxiliary magnets 220 and 221 may have a cylindrical geometry. If so, the flat surfaces (cylinder ends) of auxiliary magnets 220 and 221 are oriented in approximate perpendicular relationship to the surfaces of auxiliary lenses 206 and 208.

In an alternative embodiment, not shown, auxiliary magnets 220 and 221 are retained directly within arms 216 and 217, and a separate retainer in unnecessary. In another alternative embodiment, the ends of arms 216 and 217 are made of a magnetic material. In an alternative embodiment, a magnetic member is included in arms 216 and 217. In another alternative embodiment, arms 216 and 217 are magnets. Thus, in the various disclosed embodiments, arms 216 and 217 are magnetically attractable.

The preferred embodiments of primary frame 102 and auxiliary frame 202 illustrated surround the entire perimeter of primary lenses 106 and 107 and auxiliary lenses 206 and 207 respectively. Alternatively, primary frame 102 may only partially surround the perimeter of primary lenses 106 and 107. Likewise, auxiliary frame 202 may only partially surround the entire perimeter of auxiliary lenses 206 and 207. Such configurations are known in the industry as “open edge.”

In another preferred embodiment, primary lenses 106 and 107 are attached directly to primary bridge 104. In this embodiment, primary extensions 108 and 109 are attached directly to primary lenses 106 and 107. In another preferred embodiment, auxiliary lenses 206 and 207 are attached directly to auxiliary bridge 204. In this embodiment, auxiliary extensions 208 and 209 are attached directly to auxiliary lenses 206 and 207. Such configurations are known in the industry as “frameless.”

### OPERATION OF THE PREFERRED EMBODIMENTS

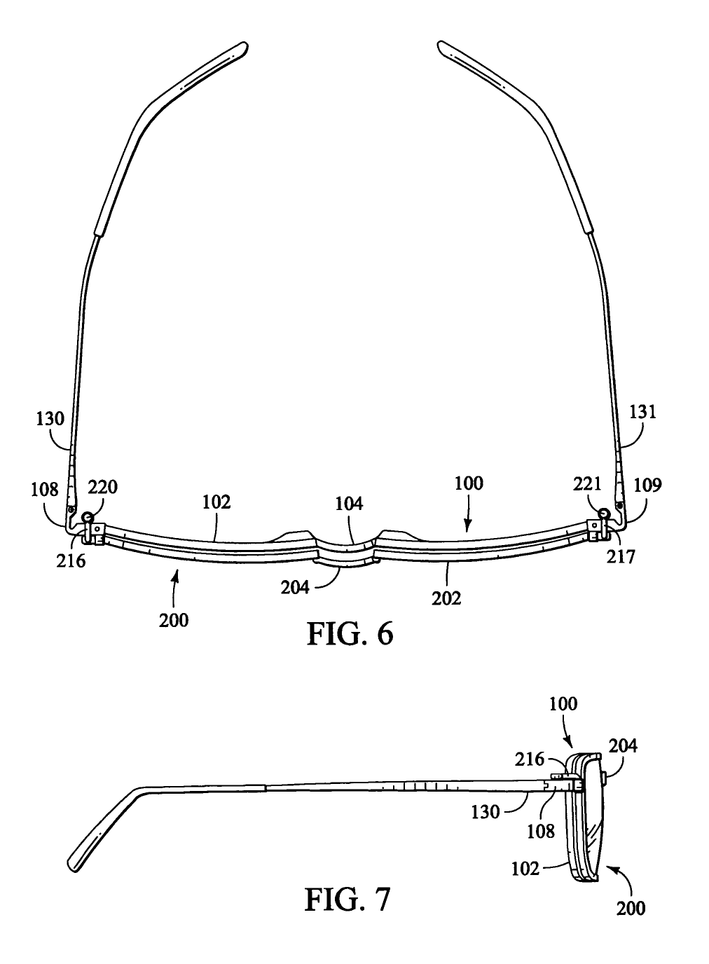

FIG. 6 is a top view of the preferred embodiment disclosed in FIG. 1. In this view, primary lens assembly 100 and auxiliary lens assembly 200 are illustrated attached. Auxiliary lens assembly 200 is completely detachable from primary lens assembly 100. FIG. 7 is a side view of the preferred embodiment illustrated in FIG. 6.

Auxiliary lens assembly 200 is attachable in two positions. In a first “lowered” position, auxiliary lenses 206 and 207 are substantially aligned with primary lenses 106 and 107. This causes light to pass through both auxiliary lenses 206 and 207 and primary lenses 106 and 107 before reaching the eyes of the person wearing the device. In a second “raised” position, auxiliary lenses 206 and 207 are removed from alignment with primary lenses 106 and 107. This causes light to pass only through primary lenses 106 and 107 before reaching the eyes of the person wearing the device.

In FIGS. 6 and 7, auxiliary lens assembly 200 is illustrated in the lowered position. In a preferred embodiment, primary lenses 106 and 107 are corrective lenses and auxiliary lenses 206 and 207 are light transmission reducing lenses, such as a polarizing, absorbing, refracting, photochromatic, or reflecting lens, or any combination thereof (i.e., sunglasses). If the wearer needs to see only through primary lens assembly 100, he/she may optionally remove auxiliary lens assembly 200, or rotate it to the raised position. A preference to rotate auxiliary lens assembly 200 to the raised position may occur, for example, when the eyeglass wearer drives his/her automobile from a brightly sunlit environment into a tunnel or parking garage, or needs to read a newspaper or mobile telephone display while outside. In these instances the eyeglass wearer may not wish to handle and store auxiliary lens assembly 200 at that moment, and flipping auxiliary lens assembly 200 up into the raised position is more convenient, and/or safer.

In another preferred embodiment, one or both of primary lenses 106 and 107 are corrective lenses and auxiliary lenses 206 and 207 are impact resistant safety lenses. This configuration permits the eyeglass wearer the convenience of utilizing generic safety lenses fitted to his or her prescription. Auxiliary lens assembly 200 and safety lenses 206 and 207 can be flipped up and out of the way when close visual inspection is required without the need for protection. By not having to remove a separate pair of safety glasses, they are not easily misplaced. Also, if safety lenses 206 and 207 are damaged, they can be replaced without having to replace the more expensive prescription lenses.

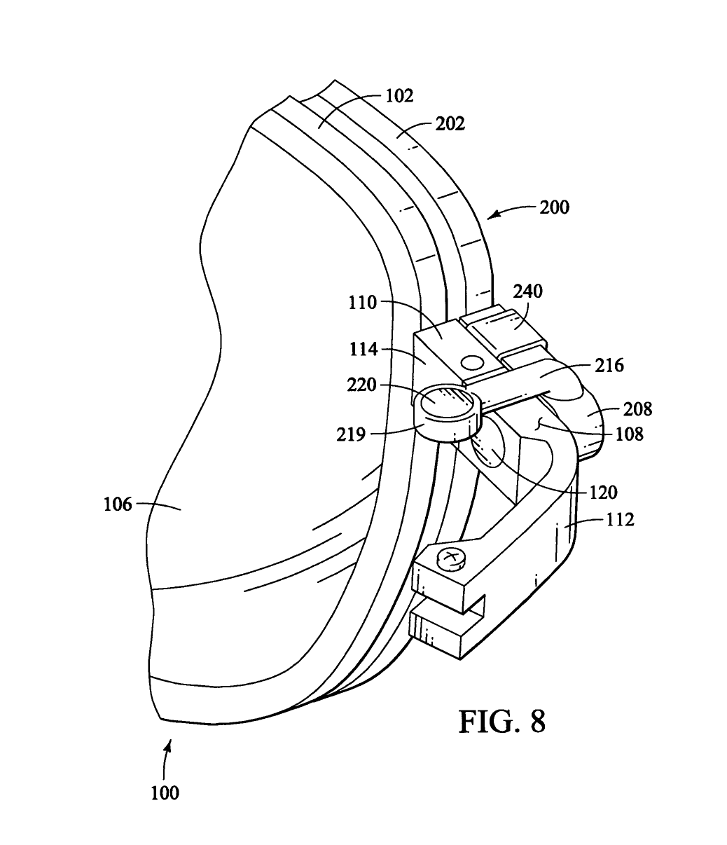

FIG. 8 is an isometric breakout view of the preferred embodiment disclosed in FIG. 7, showing the auxiliary lens assembly 200 attached, and in the lowered position. When auxiliary lens assembly 200 is in the lowered position, rear surface 214 of auxiliary extension 208 is positioned adjacent to front surface 112 of primary extension 108. In the lowered position, the proximity of rear surface 214 to front surface 112 permits magnetic engagement between primary magnet 120 and auxiliary extension 208 for securing auxiliary lens assembly 200 to primary lens assembly 100. Similarly, primary magnet 121 magnetically engages auxiliary extension 209.

Referring to FIG. 8, in the preferred embodiment, when auxiliary lens assembly 200 is in the lowered position, downward movement of auxiliary lens assembly 200 relative to primary lens assembly 100 is limited by contact between arms 216 and 217 with top surfaces 110 and 111 of primary extensions 108 and 109 respectively.

Referring to FIG. 8, in a preferred embodiment, a sleeve 240 is located on auxiliary extension 208. Similarly, a sleeve 241 is located on auxiliary extension 209. Sleeves 240 and 241 are preferably made of a stretchable elastic material to allow easy placement onto auxiliary extensions 208 and 209. Sleeves 240 and 241 operate to prevent undesirable wear on front surfaces 112 and 113 and top surfaces 110 and 111 which may result from moving auxiliary lens assembly 200 between the lowered and raised positions. Sleeves 240 and 241 are optional to the basic operation of the disclosed invention.

In an alternative embodiment, one or more pairs of top surfaces 110 and 111, front surfaces 112 and 113, and/or rear surfaces 214 and 215, are coated with a protective coating to prevent undesirable wear. The protective coating operates to prevent undesirable wear on front surfaces 112 and 113 and top surfaces 110 and 111 which may result from moving auxiliary lens assembly 200 between the lowered and raised positions. In a still more preferred embodiment, the protective coating is a Teflon® type material.

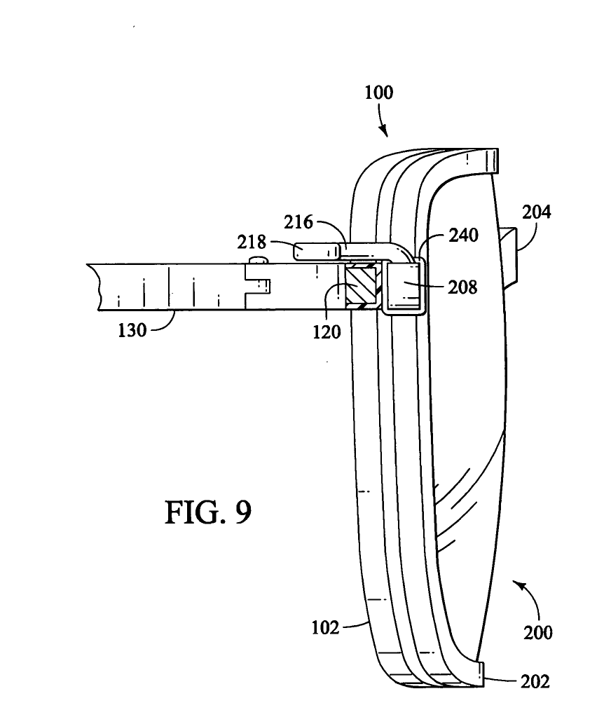

FIG. 9 is a cross-sectional view of the preferred embodiment disclosed in FIG. 8, showing auxiliary lens assembly 200 attached, and in the lowered position. In the preferred embodiment, primary magnets 120 and 121 are positioned substantially flush with rear surfaces 114 and 115 of primary extensions 108 and 109 respectively. This benefits the aesthetic design by locating primary magnets 120 and 121 in a manner that renders them undetectable when primary lens assembly 100 is viewed by someone other than the eyeglass wearer. Additionally, this position has the benefit of providing contacting magnetic engagement between primary magnets 120 and 121 and auxiliary magnets 220 and 221 when auxiliary lens assembly 200 is in the raised position.

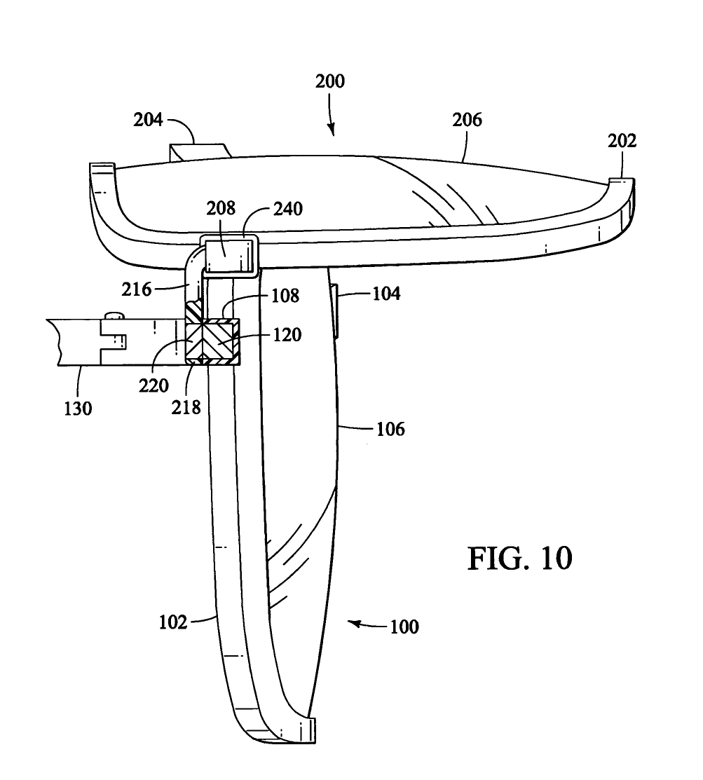

FIG. 10 is a cross-sectional view of the preferred embodiment disclosed in FIG. 9, showing auxiliary lens assembly 200 attached, and in the raised position. In the raised position, auxiliary lenses 206 and 207 are removed from alignment with primary lenses 106 and 107. This causes light to pass only through primary lenses 106 and 107 before reaching the eyes of the person wearing the device, without the need to remove and store auxiliary lens assembly 200. This is most useful when the need to have light pass only through primary lenses 106 and 107 is temporary.

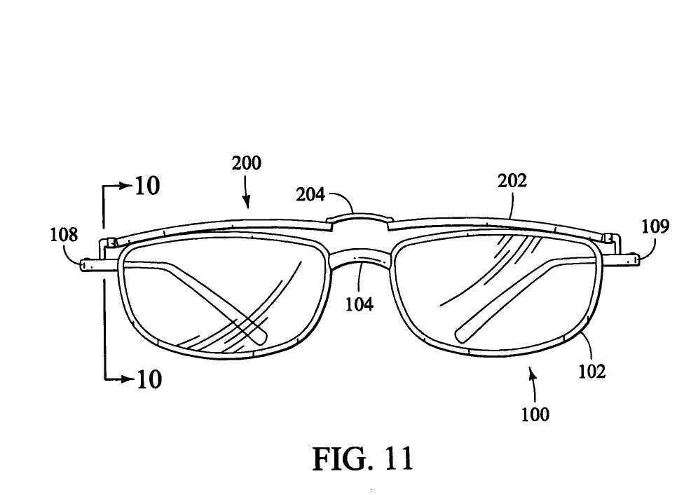

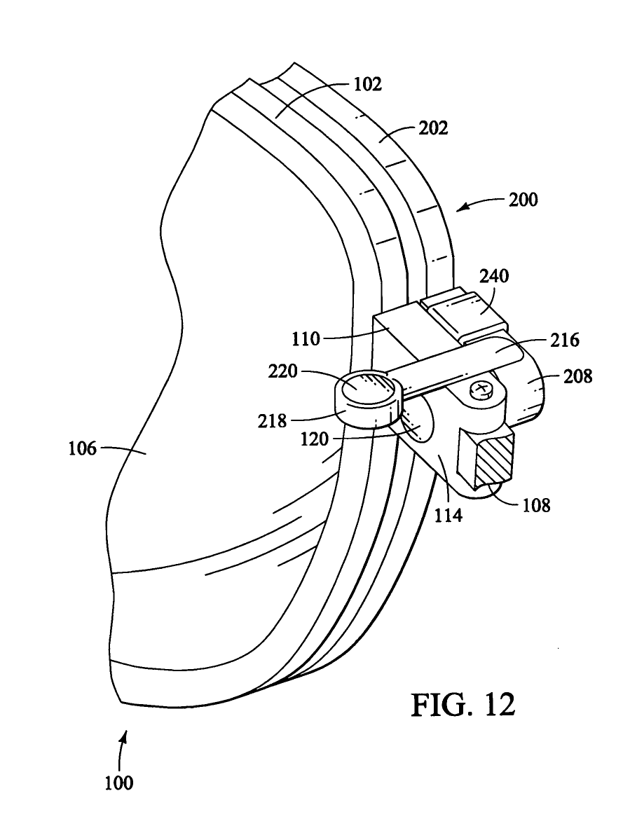

As seen in FIG. 10, in the raised position, auxiliary lens assembly 200 is positioned directly above primary lens assembly 100. Auxiliary magnets 220 and 221 magnetically engage primary magnets 120 and 121 to maintain attachment of auxiliary lens assembly 200 in the raised position relative to primary lens assembly 100. In a more preferred embodiment, best seen in FIG. 11, when auxiliary lens assembly 200 is in the raised position, downward movement of auxiliary lens assembly 200 relative to primary lens assembly 100 is limited by contact between auxiliary lenses 206 and 207 with primary frame 102. In an alternative embodiment, when auxiliary lens assembly 200 is in the raised position, downward movement of auxiliary lens assembly 200 relative to primary lens assembly 100 is limited by contact between auxiliary frame 202 and primary frame 102.

It will be readily apparent to those skilled in the art, and the general principles defined herein may be applied to other embodiments and applications without departing from the spirit and scope of the present invention.

1. An eyewear system comprising:
a primary lens assembly comprising;
a primary frame for retaining a pair of primary lenses;
a pair of primary magnets attached to the primary frame;
an auxiliary lens assembly comprising;
an auxiliary frame for retaining a pair of auxiliary lenses;
a pair of first magnetic members;
a pair of second magnetic members; and,
whereas the primary magnets magnetically engage the first magnetic members when the auxiliary lenses are substantially aligned with the primary lenses; and,
whereas the primary magnets are magnetically engagable with the second magnetic members when the auxiliary frame is rotated upward.

2. An eyewear system comprising:
a primary lens assembly comprising;
a primary frame for retaining a pair of primary lenses;
a pair of primary magnetic members attached to the primary frame;
an auxiliary lens assembly comprising;
an auxiliary frame for retaining a pair of auxiliary lenses;
a pair of first auxiliary magnets;
a pair of second auxiliary magnets; and,
whereas the primary magnetic members magnetically engage the first magnets when the auxiliary lenses are substantially aligned with the primary lenses; and,
whereas the primary magnets are magnetically engagable with the second magnetic members when the auxiliary frame is rotated upward.

3. An eyewear system comprising:
a primary lens assembly comprising;
a primary frame for retaining a pair of primary lenses;
a pair of primary extensions extending from opposite sides of the primary frame; and,
a primary magnet located in each primary extension;
an auxiliary lens assembly comprising;
an auxiliary frame for retaining a pair of auxiliary lenses;
a pair of magnetically attractable auxiliary extensions extending from opposite sides of the auxiliary frame;
an arm extending rearward from each auxiliary extension, and,
an auxiliary magnet located in each arm; and,
whereas the primary magnets magnetically engage the auxiliary extensions when the auxiliary lenses are substantially aligned with the primary lenses; and,
whereas the primary magnets are magnetically engagable with the auxiliary magnets when the auxiliary frame is rotated upward.

4. The eyewear system of claim 1, further comprising:
a leg portion attached to each primary lens.

5. The eyewear system of claim 1, further comprising:
whereas the arms contact the primary frame extension when the auxiliary frame is aligned with the primary frame so as to further prevent disengagement of the auxiliary lens assembly from the primary lens assembly.

6. The eyewear system of claim 1, further comprising:
a plastic sleeve located on the auxiliary extension.

7. An eyewear system comprising:
a primary lens assembly comprising;
a primary frame for retaining a pair of primary lenses;
a pair of primary extensions extending from opposite sides of the primary frame; and,
an auxiliary lens assembly comprising;
an auxiliary frame for retaining a pair of auxiliary lenses;
a pair of auxiliary extensions extending from opposite sides of the auxiliary frame;
a first auxiliary magnet located in each auxiliary extension;
an arm extending rearward from each auxiliary extension, and,
a second auxiliary magnet located in each arm; and,
whereas the primary magnets magnetically engage the first auxiliary magnets when the auxiliary frame is aligned substantially parallel to the primary frame; and,
whereas the primary magnets are magnetically engagable with the second auxiliary magnets when the auxiliary frame is aligned substantially perpendicular to the primary frame.
